(19) United States
(12) Patent Application Publication
(10) Pub. No.: US 2014/0222453 A1
(43) Pub. Date: Aug. 7, 2014

(54) System and Methods for Dynamically Matching Sponsors with Vendors

(71) Applicant: Biofficient, Inc., Hopkinton, MA (US)

(72) Inventors: Karen Wills, Hopkinton, MA (US); Bret Siarkowski, Marlborough, MA (US); Miguel Bautista, Framingham, MA (US)

(73) Assignee: BIOFFICIENT, INC., Hopkinton, MA (US)

(21) Appl. No.: 14/176,033

(22) Filed: Feb. 7, 2014

Related U.S. Application Data
(60) Provisional application No. 61/762,144, filed on Feb. 7, 2013.

(51) Int. Cl. G06Q 50/22; G06Q 10/06; G06Q 30/02

(52) U.S. Cl. CPC G06Q 50/22; G06Q 30/0201; G06Q 10/0637
USPC 705/2

(57) ABSTRACT

A system and methods for dynamically matching sponsors with vendors in connection with a request for proposal (“RFP”) are disclosed. In at least one embodiment, the system provides a central computing system and a database server containing data related to each of the sponsor, the vendors, and the RFP. The sponsor is able to create the RFP and provide an associated confidential disclosure agreement (“CDA”). The database server is searched for vendors that the sponsor would potentially find suitable and compiles said vendors in a matched vendors list. The sponsor is able to review the matched vendors list and decide which should receive the RFP. Each contacted vendor must accept the CDA before gaining access to the RFP. If interested, each contacted vendor must complete an electronic proposal form, at which point the sponsor is able to review the completed forms and select one of the matched vendors.

The present application claims priority pursuant to 35 U.S.C. §119(e) to U.S. Provisional Patent Application Ser. No. 61/762,144, filed Feb. 7, 2013, the content of which are hereby incorporated by reference in its entirety.

The nature of matching sponsors and vendors for a comprehensive request for proposal (“RFP”) is a very complex process as there are a multitude of factors that have to be considered. The complexity of the process increases in the field of medical research, for example, when dealing with clinical trials or a need to identify a manufacturer, where there are a large number of variables that have to be satisfied. Currently, RFP's are generally processed manually through a process where both sides of the RFP process have to spend a considerable amount of time determining if each is the right match for the other.

To overcome the limitations of manual processing, it is advantageous to use an automated matching process that would collect all of the information necessary from both sides of the RFP process and match the right provider (hereinafter referred to generally as a “vendor”) to the right customer (hereinafter referred to generally as a “sponsor”) in an efficient manner. Aspects of the present specification fulfill these needs and provide further related advantages as described in the following summary.

### SUMMARY

The present specification relates generally to methods associated with transactions involving requests for proposals and/or information and the receipt of proposals and/or information from vendors, and more particularly a system and methods for dynamically matching sponsors with vendors in connection with a given request for proposal or request for information. Aspects of the present specification teach certain benefits in construction and use which give rise to the exemplary advantages described below.

The present specification solves the problems described above by providing a system and methods for matching sponsors with vendors. In at least one embodiment, a central computing system is configured for receiving and processing data related to an at least one sponsor, an at least one vendor, and an at least one request for proposal or request for information (hereinafter referred to generally as an “RFP”). Using an at least one computing device in communication with the computing system, a sponsor account is created for the at least one sponsor and a vendor account is created for the at least one vendor. Once registered with the system, the sponsor is able to create the RFP and provide an associated confidential disclosure agreement (“CDA”) via the computing system. The computing system then searches the database server for vendors that the sponsor would potentially find suitable for the project associated with the RFP and compiles said vendors in a matched vendors list. The sponsor is able to review the matched vendors list and decide which matched vendors should receive the RFP. Each contacted vendor must first accept the CDA before gaining access to the RFP. If interested, each contacted vendor must complete and submit an electronic proposal form, at which point the sponsor is able to review the completed forms and select one of the matched vendors to provide the requested services.

Other features and advantages of aspects of the present specification will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present specification. In such drawings:

FIG. 1 is a simplified schematic view of an exemplary system for dynamically matching sponsors with vendors, in accordance with at least one embodiment;

FIGS. 2 and 3 are flow diagrams illustrating an exemplary method for dynamically matching sponsors with vendors, in accordance with at least one embodiment; and

FIGS. 4-7 are illustrations of exemplary graphical user interfaces, as displayed on an exemplary computing device, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

The above described drawing figures illustrate aspects of the invention in at least one of its exemplary embodiments, which are further defined in detail in the following description. Unless defined otherwise, all technical and scientific terms used herein have the same meaning as commonly understood by one of ordinary skill in the art.

The term “sponsor” as used herein, and without limitation, refers to any entity that may be interested obtaining research, manufacturing or related services from an external source. Such entities may be biotechnology companies, universities, research institutions, non-profit organizations, charities, pharmaceutical companies, government health agencies or the like. Non-limiting examples of such services include preparation and formulation of a drug, conducting clinical trials, manufacturing a drug, evaluation of the monetary value of a drug and evaluating the market conditions for a drug launch.

The term “vendor” as used herein, without limitation, refers to any entity that provides services to the sponsor. The vendor may be a medical equipment manufacturing company, a contract research organization, a contract manufacturing organization, a valuation organization or the like.

The term “RFP data” as used herein, without limitation, means data and other information obtained via a request for proposal. Usually such data is provided by a sponsor and a vendor. However, for the current purpose it may also be submitted by a user, a third party or any other party who is involved in any manner in the RFP process.

The term “RFI data” as used herein, without limitation, means data obtained via a request for information. Usually such data is provided by a vendor. However, for the current purpose it may also be submitted by a sponsor, user, a third party or any other party who is involved in any manner in the RFP process.

The term “user”, as used herein, without limitation, may be any individual or entity. In some cases, the methods disclosed in this application may also be used (or interfaced) with other software. In such cases the “user” is a program or software.

The term “third party” refers to a source that may not be a vendor, sponsor or a user.

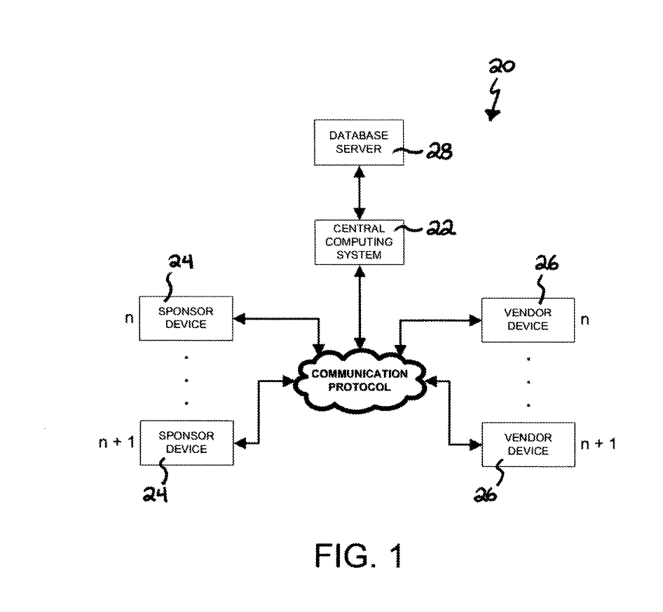

Turning now to FIG. 1, there is shown a simplified schematic view of an exemplary matching system 20 for dynamically matching an at least one sponsor with an at least one vendor in connection with an at least one RFP created by the sponsor. The system 20 provides, in at least one embodiment, a central computing system 22 configured for receiving, processing and transmitting data related to each of the at least one sponsor, the at least one vendor, and the at least one RFP. The system 20 further provides, in at least one embodiment, an at least one sponsor device 24 and an at least one vendor device 26 (referred to herein collectively as “computing devices”) each in selective communication with the computing system 22. Additionally, in at least one embodiment, a database server 28 is in communication with the computing system 22 and configured for selectively storing said data related to the at least one sponsor, vendor and RFP.

At the outset, it should be noted that the means for allowing communication between each of the computing system 22, at least one sponsor device 24, at least one vendor device 26, and database server 28 may be any wired- or wireless-based communication protocol (or combination of protocols) now known or later developed. As such, the present specification should not be read as being limited to any one particular type of communication protocol, even though certain exemplary protocols may be mentioned herein for illustrative purposes. It should also be noted that the terms “sponsor device” and “vendor device” are intended to include any type of computing device now known or later developed, such as desktop computers, mobile phones, smartphones, laptop computers, tablet computers, personal data assistants, gaming devices, etc.

With continued reference to FIG. 1, in the exemplary embodiment, the computing system 22 contains the hardware and software necessary to carry out the exemplary methods for dynamically matching the at least one sponsor with the at least one vendor as described herein. Furthermore, in at least one embodiment, the computing system 22 comprises a plurality of computing devices selectively working in concert with one another to carry out the exemplary methods for dynamically matching the at least one sponsor with the at least one vendor as described herein. In at least one alternate embodiment, the computing system 22 and database server 28 are one and the same. The at least one sponsor device 24 is in the possession of the at least one sponsor that is in need of appropriate services from one or more vendors. The at least one vendor device 26 is in the possession of the at least one vendor that is desirous of providing its services to one or more sponsors. It should be noted that while the present specification is described herein in the context of the pharmaceutical industry, use of this context is solely for illustrative purposes. As such, in further embodiments, the present specification may be utilized in any other context or industry—now known or later conceived—wherein one party is in need of particular goods or services to be provided or rendered by another party.

Generally speaking, and as described in detail below, in at least one embodiment, the computing system 22 maintains an at least one database of sponsors and vendors and provides a website portal through which the sponsors and vendors may utilize the various functions capable of being carried out by the computing system 22, as described in detail below. In at least one further embodiment, either alternatively or in addition to the website portal, each of the at least one sponsor device 24 and at least one vendor device 26 provides a mobile application or similar software in communication with the computing system 22, through which the sponsors and vendors, respectively, may utilize the various functions capable of being carried out by the computing system 22, as described in detail below.

In use, in at least one embodiment, if the sponsor is a new user/member of the system 20, the sponsor must first properly register with the computing system 22 by creating an account via the sponsor device 24—to be stored in the database server 28—and providing various sponsor-related data, which may include but is not limited to a sponsor name, sponsor address, sponsor contact information, sponsor description, and any other data relevant to the potential business relationship between the sponsor and at least one vendor. For example, in the context of the pharmaceutical industry, such sponsor-related data might further include data concerning clinical study Phases, study designs, therapeutic areas, study types, formulation types and routes of administration, settings supported, regulatory authorities, regulatory services, quality, safety, data, information technology, statistics, patient recruitment, sites, studies, investigators, routine safety labs, and central imaging services. In at least one embodiment, while the sponsor is able to provide the sponsor-related data, the computing system 22 is also capable of seeking out such data automatically by accessing appropriate third party databases.

Similarly, in at least one embodiment, if the vendor is a new user/member of the system 20, the vendor must first properly register with the computing system 22 by creating an account via the vendor device 26—to be stored in the database server 28—and providing various vendor-related data, which may include but is not limited to a vendor name, vendor address, vendor contact information, vendor description, vendor ratings, average bid size, average response time, and any other data relevant to the potential business relationship between the vendor and at least one sponsor. For example, in the context of the pharmaceutical industry, such vendor-related data might further include data concerning the size of the vendor (i.e., financial size, number of employees, size of office space, size of lab space, etc.), the types of services that the vendor is capable of rendering, the services that the vendor has rendered to other sponsors, and the names of such sponsors with which the vendor has worked. In at least one embodiment, while the vendor is able to provide the vendor-related data, the computing system 22 is also capable of seeking out such data automatically by accessing appropriate third party databases, crowd-sourced data, as well as the database server 28. For example, in such an embodiment, the computing system 22 is configured to dynamically update the vendor's account information based on any new vendor-related activity that occurs within the system 20.

Once the sponsor has created an account with the computing system 22, the sponsor is able to log into the computing system 22—again, via the sponsor device 24—at which point the computing system 22 allows the sponsor access to any projects, RFP's and vendors that are associated with the sponsor, as discussed further below. In the exemplary embodiment, the associated projects, RFP's and vendors are appropriately displayed via an at least one user interface 30 provided by a website portal that is hosted by the computing system 22 and/or database server 28. In at least one further embodiment, either alternatively or in addition to the website portal, the at least one user interface 30 is provided by a mobile application or similar software in communication with the computing system 22 and installed on the at least one sponsor device 24 and at least one vendor device 26. From the user interface 30, the sponsor is able to selectively create new projects, new RFP's associated with said projects, manage existing projects and RFP's created by the sponsor, search for prospective vendors for a given project, and present and negotiate service proposals with one or more vendors to whom an RFP was sent, among other tasks, in at least one embodiment.

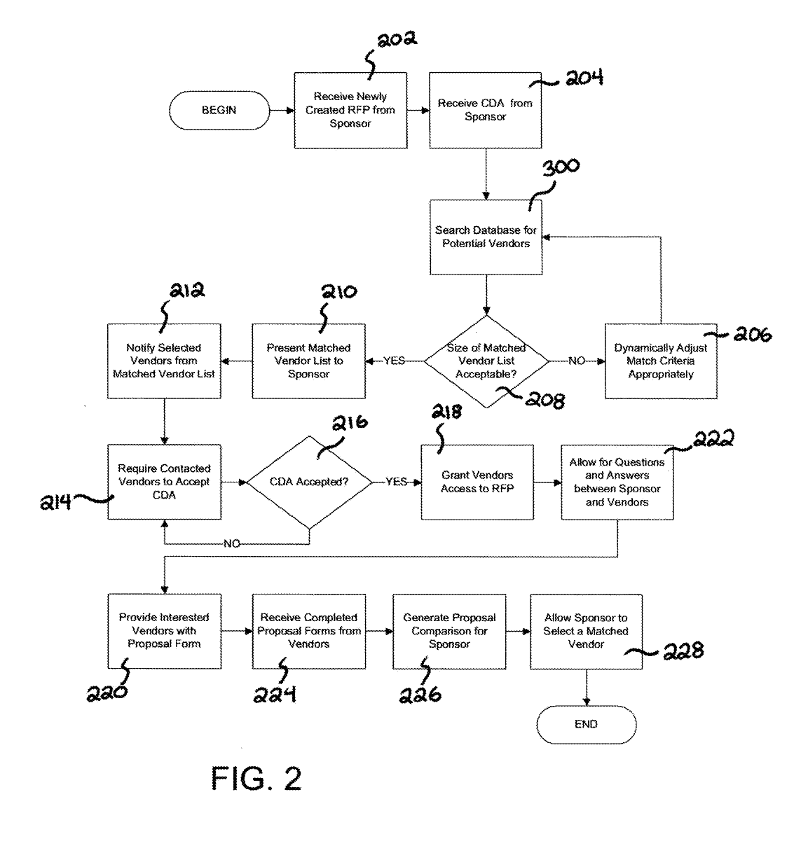

In at least one embodiment, as illustrated in the flow diagram of FIG. 2, upon the sponsor creating a new project via the sponsor device 24, the sponsor is able to create an at least one RFP related to the project (202)—to be stored in the database server 28. In the exemplary embodiment, the RFP includes a project summary, a list of project services that are needed by the sponsor, a list of deliverables that the at least one vendor would be expected to provide, a project timeline having key milestone dates related to both the RFP and the project itself, and vendor criteria setting forth the particular qualities that the sponsor would like the vendor to embody (i.e., desired types and levels of experience, desired physical location, desired types of services, etc.). Thus, the sponsor is able to provide each of these items of information to the computing system 22 as part of the RFP. In further embodiments, the at least one RFP may contain any other details pertinent to the sponsor, the project, or the ideal vendor, dependent at least in part on the context in which the system 20 is to be utilized. As mentioned above, in at least one embodiment, the data associated with the RFP may be selectively modified by the sponsor as needed.

In at least one embodiment, as discussed further below, the RFP includes a black list comprising a list of vendors with which the sponsor refuses to work. Relatedly, in at least one embodiment, the RFP includes a white list comprising a list of vendors with which the sponsor will only work. In alternate such embodiments, one or both of the black list and white list is contained more globally as part of the sponsor data so as to apply to all RFP's the sponsor may create.

In at least one embodiment, the RFP also includes a confidential disclosure agreement (“CDA”). In a bit more detail, in at least the pharmaceutical industry, it is customary to require a vendor to sign a CDA before the vendor is allowed to view an RFP. In one such embodiment, with continued reference to FIG. 2, an initial CDA corresponding to the RFP is uploaded to the computing system by the sponsor (204). As discussed further below, in the event that multiple vendors are matched and subsequently contacted by the sponsor, each vendor is given the ability to negotiate modifications to their individual CDA version via the computing system 22 before agreeing to its terms. Thus, the computing system 22 allows the sponsor and the at least one vendor to edit, track changes, and save CDA documents in a secure, efficient fashion with an audit trail without having to rely on exchanging traditional e-mail attachments or hard copies. Furthermore, different vendors could then have different versions of the CDA with sponsor.

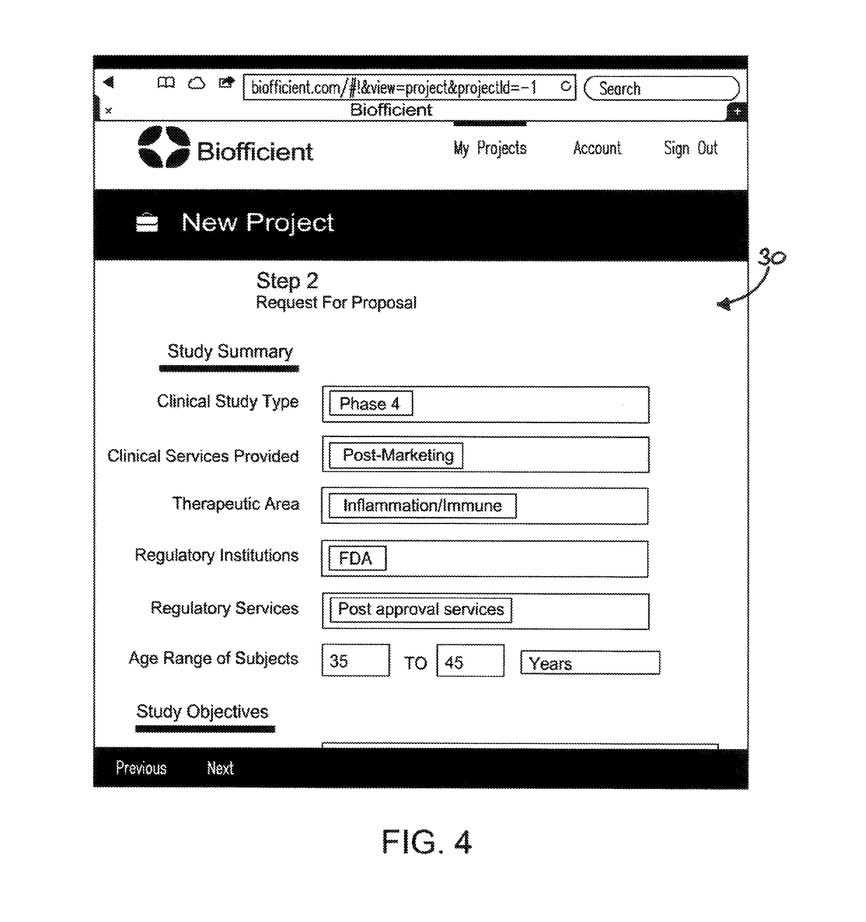

As illustrated in the user interface 30 shown in FIG. 4, in the context of the pharmaceutical industry, such RFP data might, for example, include data concerning clinical study Phases, study designs, study objectives, clinical services provided, therapeutic areas, indications, study types, formulation types and routes of administration, settings, regulatory institutions, regulatory services, and subject-related information such as age range, number and gender. Exemplary study types may include, without limitation, in-vivo study, in-vitro study, microbial study, animal study, human study, etc. Exemplary clinical study types may include, without limitation, Phase I study, Phase II study, Phase III study, Phase IV study, a stage within a Phase I, Phase II, Phase III or Phase IV study, further stages of such Phase studies, etc.

Phase I includes the initial introduction of an investigational new drug into humans. Phase I studies are typically closely monitored and may be conducted in patients or normal volunteer subjects. These studies are designed, without limitation, to determine the metabolism and pharmacologic actions of the drug in humans, the side effects associated with increasing doses, and, if possible, to gain early evidence on effectiveness. During Phase I, sufficient information about the drug's pharmacokinetics and pharmacological effects is generally obtained to permit the design of well-controlled, scientifically valid, Phase II studies. The total number of subjects and patients included in Phase I studies varies with the drug, but is, without limitation generally in the range of a few patients to many patients, and in one aspect can be in the range of 20 to 80 patients.

Phase I studies also include studies of drug metabolism, structure-activity relationships, and mechanism of action in humans, as well as studies in which investigational drugs are used as research tools to explore biological phenomena or disease processes.

Phase II includes, without limitation, the controlled clinical studies conducted to evaluate the effectiveness of the drug for a particular indication or indications in patients with the disease or condition under study and to determine the common short-term side effects and risks associated with the drug. Phase II studies are typically well controlled, closely monitored, and conducted in a relatively small number of patients, usually involving no more than several hundred subjects.

Phase III studies, without limitation, are expanded controlled and uncontrolled trials. They are performed after preliminary evidence suggesting effectiveness of the drug has been obtained, and are intended to gather the additional information about effectiveness and safety that is needed to evaluate the overall benefit-risk relationship of the drug and to provide an adequate basis for physician labeling. Phase III studies usually include from several hundred to several thousand subjects.

Concurrent with marketing approval, the FDA may seek agreement from the sponsor to conduct certain post-marketing (Phase IV) studies to delineate additional information about the drug's risks, benefits, and optimal use. These studies could include, but would not be limited to, studying different doses or schedules of administration than were used in Phase II studies, use of the drug in other patient populations or other stages of the disease, or use of the drug over a longer period of time.

With continued reference to FIG. 4, exemplary clinical services may include, without limitation, clinical training, epidemiology, health outcomes, institutional review board, medical monitoring, medical safety, medical writing, post-marketing, project management, protocol development, etc. Exemplary therapeutic areas may include, without limitation, cardiology, vascular diseases, maxillofacial field, dental and oral, dermatology, plastic surgery, endocrinology, gastroenterology, genetic disease, hematology, hepatology, immunology, infectious diseases, musculoskeletal, nephrology, neurology, nutrition and weight loss, urology, obstetrics, gynecology, oncology, ophthalmology, otolaryngology, orthopedics pediatrics, neonatology, toxicology, podiatry, psychiatry, psychology, pulmonary, respiratory diseases, rheumatology, sleep, trauma, emergency medicine, etc. Exemplary regulatory services may include, without limitation, investigational new drug (“IND”), clinical trial application (“CTA”) and investigational manufacturing product dossier (“IMPD”) requirements and filings, regulatory authority meeting briefing packages, new drug application (“NDA”), biologic license application (“BLA”), marketing authorization application (“MAA”) and abbreviated new drug application (“ANDA”) requirements and filings, annual reports, development safety update reports (“DSUR”), periodic safety update reports (“PSUR”), pediatric drug development, orphan designation applications, fast track designation applications, informed consent data, institutional review board (“IRB”) requirements, post-marketing commitment requirements, financial disclosure data provisions, etc. Exemplary regulatory institutions may include, without limitation, the FDA, EPA, DEA, European Medicines Agency, or any other regulatory institution now know or later created.

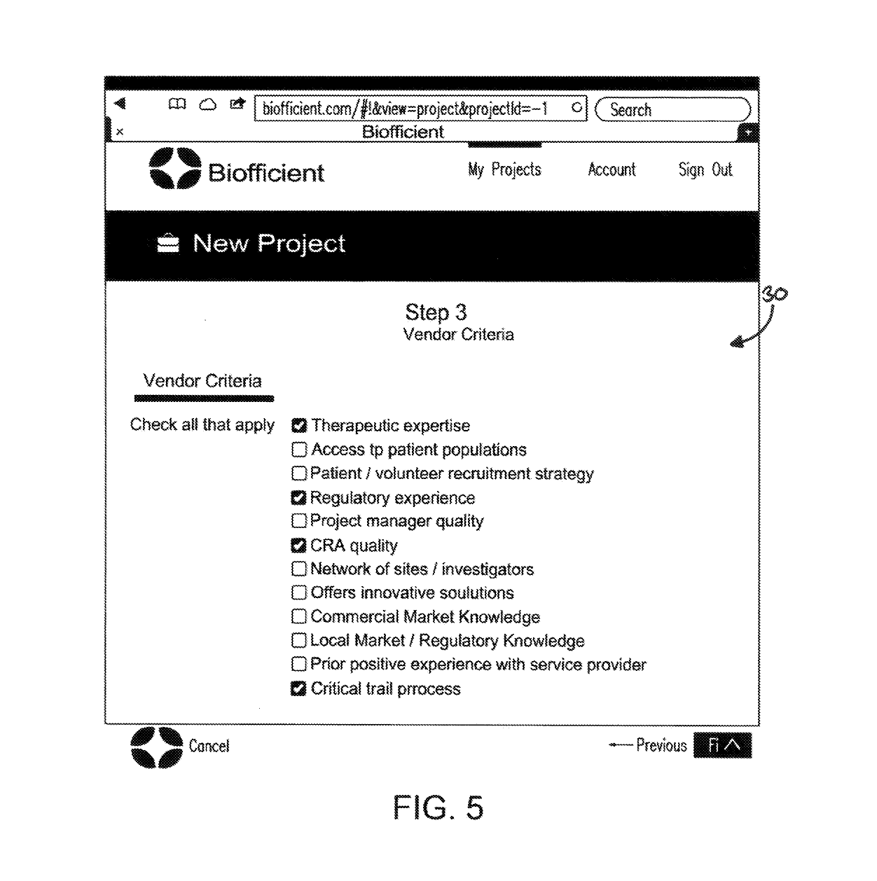

As illustrated in the user interface 30 shown in FIG. 5, in the context of the pharmaceutical industry, vendor criteria setting forth the particular qualities that the sponsor would like the vendor to embody might, for example, include whether the vendor possesses therapeutic expertise, access to patient populations, patient or volunteer recruitment strategies, regulatory experience, a quality project manager, CRA quality, a sufficient network of sites and/or investigators, the ability to provide innovative solutions, commercial market knowledge, local market knowledge, regulatory knowledge, a critical trial process, whether the sponsor has had prior positive experience with the vendor, etc. In the exemplary embodiment, the user interface provides the sponsor with a series of checkboxes for the various vendor criteria, thereby ensuring uniformity. However, in further embodiments, the sponsor is able to create custom vendor criteria.

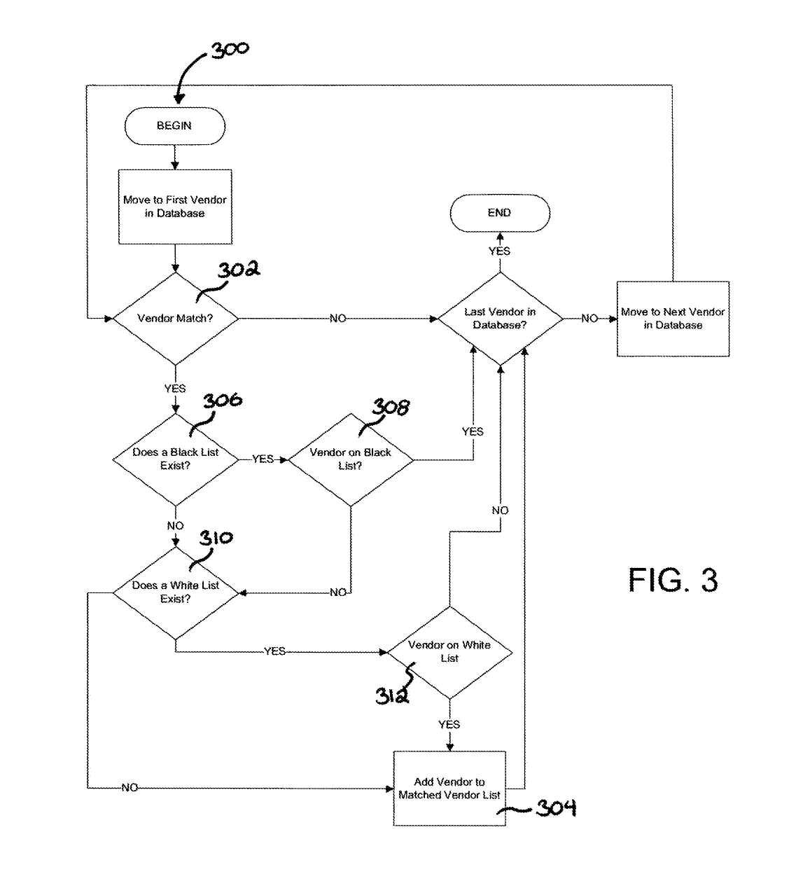

As illustrated in the flow diagram of FIG. 3, in at least one embodiment, upon the sponsor creating the RFP (202) and uploading the CDA (204), the computing system 22 begins to automatically search the database server 28 for one or more appropriate vendors that the sponsor would potentially find suitable for the associated project (300). In at least one embodiment, the computing system 22 searches for such vendors using one or more of the sponsor data, RFP data, vendor criteria, and vendor data (including data related to prior projects on which a given vendor has worked). For example, in one such embodiment, the computing system 22 compares each of the sponsor data, RFP data and vendor criteria against the vendor data for each vendor in the database server 28 in order to determine which vendors possess the appropriate qualifications (as defined by the sponsor data, RFP data and vendor criteria) (302). For vendors that are determined by the computing system 22 to possess a minimum acceptable number of “matched” data points (i.e., aspects of the vendor data that match identically or at least correlate with aspects of one or more of the sponsor data, RFP data and vendor criteria, based on a sponsor-defined threshold), the computing system 22 adds such vendors to a matched vendor list (304) to be subsequently presented to the sponsor. Furthermore, in embodiments where there exists a black list associated with the sponsor or the RFP (306), the computing system 22 excludes any vendors present on the black list (308) from being on the matched vendor list. Similarly, in embodiments where there exists a white list associated with the sponsor or the RFP (310), the computing system 22 excludes any vendors not present on the white list (312) from being on the matched vendor list. In at least one further embodiment, the matched vendor list comprises both the matched vendors identified by the computing system 22 along with any vendors present on the white list (i.e., even if one or more of the matched vendors do not appear on the white list).

In at least one embodiment, the computing system 22 utilizes a dynamic multi-factor matching algorithm. In a bit more detail, in at least one such embodiment, the computing system 22 continuously and actively evaluates and re-evaluates the vendor data stored in the database server 28 as the RFP data and/or vendor data might change, and adjusts the matched vendor list accordingly.

In another embodiment, with reference again to FIG. 2, the computing system 22 utilizes an adaptive multi-factor matching algorithm through which the computing system 22 is able to dynamically adjust the matching criteria (206) in the event the resulting matched vendor list is too large or too small (208). In a bit more detail, in at least one such embodiment, the computing system 22 searches the database server 28 for vendors that are determined by the computing system 22 to possess a minimum acceptable number of matched data points in order to add those vendors to the matched vendor list. In the event the computing system 22 discovers too many vendors to add to the matched vendor list (based on a ceiling value defined by either the sponsor or the computing system 22), the computing system 22 dynamically raises the minimum acceptable number of matched data points in order to reduce the size of the matched vendor list, thereby making the process of researching and ultimately choosing a vendor easier on the sponsor. Similarly, in the event the computing system 22 fails discover enough vendors to add to the matched vendor list (based on a floor value defined by either the sponsor or the computing system 22), the computing system 22 dynamically lowers the minimum acceptable number of matched data points in order to increase the size of the matched vendor list. In a further such embodiment, rather than simply lowering the minimum acceptable number of matched data points, the computing system 22 instead selectively disregards aspects of one or more of the sponsor data, RFP data and vendor criteria having relatively less importance. For example, should the sponsor not care about where the matched vendors are located, any location data would potentially be disregarded if necessary to increase the size of the matched vendor list. This is a recursive process that continues until an acceptable number of vendors are included on the matched vendor list.

In another embodiment, the computing system 22 utilizes a combination of the dynamic and adaptive multi-factor matching algorithms. In still further embodiments, any other matching algorithm or combination of algorithms, now known or later developed, that are capable of substantially carrying out the functionality herein described, may be substituted.

With continued reference to FIG. 2, upon the computing system 22 compiling the matched vendor list of acceptable size (208), the matched vendor list is then presented to the sponsor (210). In at least one embodiment, the matched vendor list is ordered based on the strength of the match between the sponsor and each vendor, with the vendor determined by the computing system 22 to be the strongest match positioned at the top of the list. Strength of a match can be determined based on a number of methods. In one such embodiment, strength of a match is determined based on the percentage of vendor data for a given vendor that matches with one or more of the sponsor data, RFP data and vendor criteria. For example, if the computing system 22 uses one hundred different data points when searching the database server 28 for vendors, and the vendor data associated with a particular vendor matches ninety of those data points, that vendor would have a match percentage of ninety percent; which would likely be considered a relatively strong match. In still further embodiments, the matched vendor list may be ordered by the computing system 22 based on any data point chosen by the sponsor or computing system 22, such as vendor size, vendor location, etc.

With continued reference to FIG. 2, the sponsor is then given the ability to review each matched vendor in order to determine which of them (if any) should receive the RFP. Should the matched vendor list yield no desirable vendors, the sponsor—or, in an alternate embodiment, the computing system 22 automatically—is able to modify or relax one or more of the sponsor data, RFP data and vendor criteria in an attempt to broaden the pool of potential vendors. In at least one embodiment, the computing system 22 automatically chooses a pre-determined number of vendors from the matched vendor list.

For each vendor that the sponsor (or the computing system 22) decides to contact, the computing system 22 sends an appropriate notification to the vendor (212) via the vendor device 26. However, in further embodiments, any other communication means now known or later developed may be substituted. In the exemplary embodiment, the notification contains a brief summary of the RFP. Upon receiving the notification, the vendor is able to log into the computing system 22 in order to learn more about the RFP.

In at least one embodiment, once the vendor has logged into the computing system 22, before access is provided to the RFP, the vendor must first sign or otherwise accept the CDA associated with the RFP (214), either as-is or after negotiating its terms with the sponsor, as discussed above. After signing or otherwise accepting the CDA (216), the vendor is then given access to the RFP (218). If the vendor is interested, the computing system 22 provides the vendor with an electronic proposal form containing pre-defined questions and/or requests for information to be completed by the vendor and subsequently submitted via the computing system 22 (220). It should be noted that these pre-defined questions and requests for information may be created by one or more of computing system 22, the sponsor, or other users of the system 20. This not only ensures that the RFP and associated proposal remains secure, but it also assists in maintaining uniformity across the potentially numerous proposals submitted by the different matched vendors.

In at least one embodiment, the vendor is given the ability to submit questions to and receive answers from the sponsor through the computing system 22 (222). Additionally, where the sponsor allows it, the vendor is able to view select answered questions from other matched vendors to help reduce the amount of duplicate questions from amongst the matched vendors.

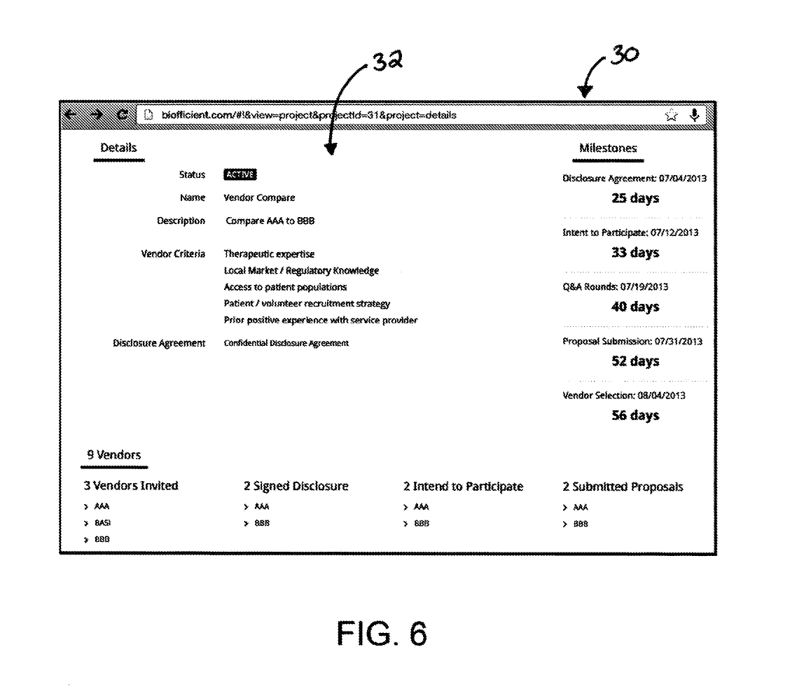

Referring now to FIG. 6, in at least one embodiment, the computing system 22 also provides, via the user interface 30, a project dashboard 32 through which the sponsor may quickly and easily view the status of each contacted vendor (i.e., number of matched vendors, number of matched vendors contacted, number of contacted vendors that have signed the CDA, number of contacted vendors that intend to participate in the RFP, number of contacted vendors that have submitted a proposal, names of contacted vendors, etc.). The project dashboard 32 also preferably includes a visual list of the key milestones related to both the RFP and the project itself (such as the deadline for vendors to sign the CDA, the deadline for vendors to submit their intent to participate in the RFP, the deadline for question and answer rounds, the deadline for vendors to submit their proposals, and the deadline by which the sponsor will select a vendor, etc.).

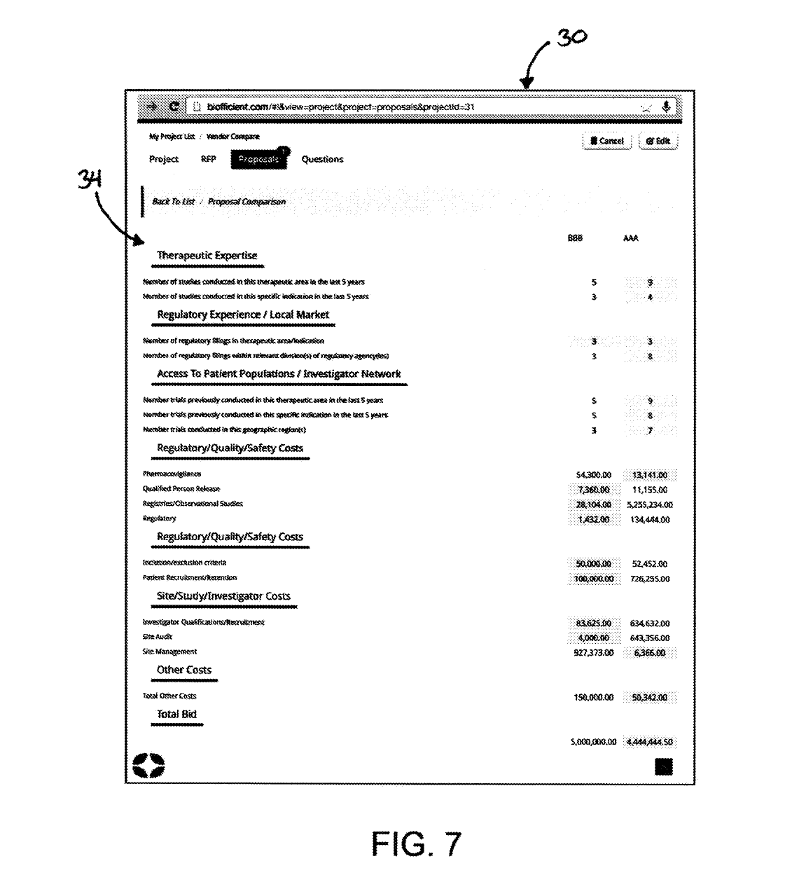

Referring now to FIG. 7 along with FIG. 2, in at least one embodiment, as vendors begin to submit their proposals in response to the RFP (224), the computing system 22 generates a proposal comparison page 34 via the user interface 30 through which data contained in each vendor's proposal is displayed in a side-by-side comparison format (226). Thus, the proposal comparison page 34 assists the sponsor in quickly and efficiently determining which matched vendor will be best suited for the project (228). In at least one such embodiment, the computing system 22 automatically highlights the most favorable response amongst the proposals for each item of the proposals.

In at least one embodiment, the computing system 22 also maintains an audit trail for each discrete project or RFP. The audit trail contains all transactions, associated with the e-procurement lifecycle associated with the project or RFP, including but not limited to time, date, machine, IP and user information for RFP creation and collaborators that contributed or edited an RFP, matching criteria, white lists, black lists, matching vendors, selected vendors, associated notifications and communications, the entire legal red-line process for the CDA and any other associated documents, responses, custom fields, pricing, experience and submission dates, questions and answers, final selection, etc.

Regarding the exemplary embodiments of the present specification as shown and described herein, it will be appreciated that a system and methods for dynamically matching sponsors with vendors in connection with a given request for proposal is disclosed. Because the principles of the invention may be practiced in a number of configurations beyond those shown and described, it is to be understood that the invention is not in any way limited by the exemplary embodiments, but is generally directed to a system and methods for dynamically matching sponsors with vendors and is able to take numerous forms to do so without departing from the spirit and scope of the invention. Furthermore, the various features of each of the above-described embodiments may be combined in any logical manner and are intended to be included within the scope of the present specification.

It should be understood that the logic code, programs, modules, processes, methods, and the order in which the respective elements of each method are performed are purely exemplary. Depending on the implementation, they may be performed in any order or in parallel, unless indicated otherwise in the present disclosure. Further, the logic code is not related, or limited to any particular programming language, and may comprise one or more modules that execute on one or more processors in a distributed, non-distributed, or multiprocessing environment.

The methods as described above may be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multi-chip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

Aspects of the present specification may also be described as follows:
1. A method for dynamically matching a sponsor with an at least one vendor in connection with a request for proposal (“RFP”), the method comprising the steps of: implementing a central computing system configured for receiving, processing and transmitting data related to each of the sponsor, the at least one vendor, and the RFP; providing a database server in communication with the computing system and configured for selectively storing said data related to the sponsor, the at least one vendor, and the RFP; using an at least one computing device in communication with the computing system to create an account associated with each of the sponsor and the at least one vendor; selectively displaying on the at least one computing device data associated with each of the sponsor, the at least one vendor, and the RFP via an at least one user interface provided by the computing system; obtaining sponsor data related to the sponsor; obtaining vendor data related to the at least one vendor; allowing the sponsor to create the RFP; obtaining RFP data related to the RFP; obtaining a confidential disclosure agreement (“CDA”) corresponding to the RFP; searching the database server for vendors that the sponsor would potentially find suitable for the project associated with the RFP; compiling said potentially suitable vendors in a matched vendors list; presenting the sponsor with the matched vendors list; allowing the sponsor to direct the computing system to send an appropriate notification to at least one of the matched vendors regarding the RFP; requiring each of the contacted vendors to accept the CDA before granting said vendor access to the RFP; providing each interested vendor with an electronic proposal form containing pre-defined questions and/or requests for information related to the RFP to be completed by the vendor; receiving a completed proposal form from each interested vendor; generating a proposal comparison page via the user interface through which data contained in each interested vendor's proposal form is displayed in a side-by-side comparison format, thereby assisting the sponsor in determining which matched vendor will be best suited for the associated project; and allowing the sponsor to select one of the matched vendors to provide the requested services.
2. The method according to embodiment 1, wherein the step of obtaining sponsor data further comprises the step of obtaining at least one of a sponsor name, sponsor address, sponsor phone number, sponsor email address, and sponsor description.
3. The method according to embodiment 2, wherein the step of obtaining sponsor data further comprises the step of obtaining data concerning at least one of clinical study Phases, study designs, therapeutic areas, study types, formulation types and routes of administration, settings supported, regulatory authorities, regulatory services, quality, safety, data, information technology, statistics, patient recruitment, sites, studies, investigators, routine safety labs, and central imaging services.
4. The method according to embodiments 1-3, wherein the step of obtaining vendor data further comprises the step of obtaining at least one of a vendor name, vendor address, vendor phone number, vendor email address, vendor description, vendor ratings, average vendor bid size, and average vendor response time for each one of the at least one vendor.
5. The method according to embodiment 4, wherein the step of obtaining vendor data further comprises the step of obtaining data concerning at least one of vendor size, types of services the vendor is capable of rendering, types of services the vendor has actually rendered to other sponsors, and the names of such sponsors with which the vendor has worked.
6. The method according to embodiments 1-5, wherein the step of obtaining RFP data further comprises the step of obtaining at least one of a project summary, a list of project services that are needed by the sponsor, a list of deliverables that the at least one vendor would be expected to provide, a project timeline having key milestone dates related to the RFP, and vendor criteria setting forth the particular qualities that the sponsor would like the at least one vendor to embody.
7. The method according to embodiment 6, wherein the step of obtaining RFP data further comprises the step of obtaining data concerning at least one of clinical study Phases, study designs, study objectives, clinical services provided, therapeutic areas, indications, study types, formulation types and routes of administration, settings, regulatory institutions, regulatory services, and subject-related information such as age range, number and gender.
8. The method according to embodiments 1-7, wherein the step of obtaining RFP data further comprises the step of obtaining a black list comprising a list of vendors with which the sponsor refuses to work.
9. The method according to embodiment 8, further comprising the step of excluding any vendors present on the black list from being on the matched vendor list.
10. The method according to embodiments 1-9, wherein the step of obtaining RFP data further comprises the step of obtaining a white list comprising a list of vendors with which the sponsor will only work.
11. The method according to embodiment 10, further comprising the step of excluding any vendors not present on the white list from being on the matched vendor list.
12. The method according to embodiments 1-11, further comprising the step of dynamically updating the vendor data related to the at least one vendor upon the occurrence of any new vendor-related activity within the computing system.
13. The method according to embodiments 1-12, further comprising the step of allowing each of the contacted vendors to selectively negotiate the terms of the CDA with the sponsor prior to accepting the CDA.
14. The method according to embodiments 1-13, wherein the step of searching the database server for vendors that the sponsor would potentially find suitable further comprises the steps of: for each vendor in the database server, comparing at least one of the sponsor data and RFP data against the associated vendor data; and for vendors that are determined by the computing system to possess a minimum acceptable number of matched data points, adding said vendors to the matched vendor list.
15. The method according to embodiments 1-14, wherein the step of searching the database server for vendors that the sponsor would potentially find suitable further comprises the step of utilizing a dynamic multi-factor matching algorithm, said matching algorithm comprising the steps of: continuously and actively evaluating and re-evaluating the vendor data associated with the at least one vendor as the RFP data and/or vendor data might change; and adjusting the matched vendor list accordingly.
16. The method according to embodiments 1-15, wherein the step of searching the database server for vendors that the sponsor would potentially find suitable further comprises the step of utilizing an adaptive multi-factor matching algorithm, said matching algorithm comprising the steps of: upon the computing system determining that the matched vendor list contains too many matched vendors, based on a pre-defined ceiling value, dynamically raising the minimum acceptable number of matched data points, thereby reducing the number of matched vendors contained in the matched vendor list; upon the computing system determining that the matched vendor list contains too few matched vendors, based on a pre-defined floor value, dynamically lowering the minimum acceptable number of matched data points, thereby increasing the number of matched vendors contained in the matched vendor list; and repeating these steps until the computing system determines that the matched vendor list contains an acceptable number of matched vendors.
17. The method according to embodiments 1-16, further comprising the step of ordering the matched vendor list based on the strength of the match between the sponsor and each matched vendor.
18. The method according to embodiments 1-17, further comprising the step of allowing each of the contacted vendors the ability to submit questions to and receive answers from the sponsor through the computing system.
19. The method according to embodiments 1-18, further comprising the step of providing, via the user interface, a project dashboard through which the sponsor may view at least one of the status of each contacted vendor and key milestones dates related to the RFP.
20. A method for dynamically matching a sponsor with an at least one vendor in connection with a request for proposal (“RFP”), the method comprising the steps of: implementing a central computing system configured for receiving, processing and transmitting sponsor data related to the sponsor, vendor data related to the at least one vendor, and RFP data related to the RFP; providing a database server in communication with the computing system and configured for selectively storing said sponsor data, vendor data and RFP data; allowing the sponsor to create the RFP using an at least one computing device in communication with the computing system; obtaining a confidential disclosure agreement (“CDA”) corresponding to the RFP; automatically searching the database server for vendors that the sponsor would potentially find suitable for the project associated with the RFP by performing the steps of: for each vendor in the database server, comparing at least one of the sponsor data and RFP data against the associated vendor data; for vendors that are determined by the computing system to possess a minimum acceptable number of matched data points, adding said vendors to a matched vendor list; upon the computing system determining that the matched vendor list contains too many matched vendors, based on a pre-defined ceiling value, dynamically raising the minimum acceptable number of matched data points, thereby reducing the number of matched vendors contained in the matched vendor list; upon the computing system determining that the matched vendor list contains too few matched vendors, based on a pre-defined floor value, dynamically lowering the minimum acceptable number of matched data points, thereby increasing the number of matched vendors contained in the matched vendor list; and repeating these steps until the computing system determines that the matched vendor list contains an acceptable number of matched vendors; presenting the sponsor with the matched vendors list; allowing the sponsor to direct the computing system to send an appropriate notification to at least one of the matched vendors regarding the RFP; requiring each of the contacted vendors to accept the CDA before granting said vendor access to the RFP; providing each interested vendor with an electronic proposal form containing pre-defined questions and/or requests for information related to the RFP to be completed by the vendor; receiving a completed proposal form from each interested vendor; and allowing the sponsor to review the completed proposal forms and select one of the matched vendors to provide the requested services.
21. A method for dynamically matching a sponsor with an at least one vendor in connection with a request for proposal (“RFP”), the method comprising the steps of: implementing a central computing system configured for receiving, processing and transmitting sponsor data related to the sponsor, vendor data related to the at least one vendor, and RFP data related to the RFP; providing a database server in communication with the computing system and configured for selectively storing said sponsor data, vendor data and RFP data; allowing the sponsor to create the RFP using an at least one computing device in communication with the computing system; obtaining a confidential disclosure agreement (“CDA”) corresponding to the RFP; searching the database server for vendors that the sponsor would potentially find suitable for the project associated with the RFP; compiling said potentially suitable vendors in a matched vendors list ordered based on the strength of the match between the sponsor and each matched vendor; presenting the sponsor with the matched vendors list; allowing the sponsor to direct the computing system to send an appropriate notification to at least one of the matched vendors regarding the RFP; requiring each of the contacted vendors to accept the CDA before granting said vendor access to the RFP; allowing each of the contacted vendors the ability to submit questions to and receive answers from the sponsor through the computing system; providing each interested vendor with an electronic proposal form containing pre-defined questions and/or requests for information related to the RFP to be completed by the vendor; receiving a completed proposal form from each interested vendor; and allowing the sponsor to review the completed proposal forms and select one of the matched vendors to provide the requested services.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only, and is not intended to limit the scope of the present invention, which is defined solely by the claims. Accordingly, the present invention is not limited to that precisely as shown and described.

Certain embodiments of the present invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar referents used in the context of describing the present invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the present invention so claimed are inherently or expressly described and enabled herein.

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor believes that the claimed subject matter is the invention.

1. A method for dynamically matching a sponsor with an at least one vendor in connection with a request for proposal (“RFP”), the method comprising the steps of:
implementing a central computing system configured for receiving, processing and transmitting data related to each of the sponsor, the at least one vendor, and the RFP;
providing a database server in communication with the computing system and configured for selectively storing said data related to the sponsor, the at least one vendor, and the RFP;
using an at least one computing device in communication with the computing system to create an account associated with each of the sponsor and the at least one vendor;
selectively displaying on the at least one computing device data associated with each of the sponsor, the at least one vendor, and the RFP via an at least one user interface provided by the computing system;
obtaining sponsor data related to the sponsor;
obtaining vendor data related to the at least one vendor;
allowing the sponsor to create the RFP;
obtaining RFP data related to the RFP;
obtaining a confidential disclosure agreement (“CDA”) corresponding to the RFP;
searching the database server for vendors that the sponsor would potentially find suitable for the project associated with the RFP;
compiling said potentially suitable vendors in a matched vendors list;
presenting the sponsor with the matched vendors list;
allowing the sponsor to direct the computing system to send an appropriate notification to at least one of the matched vendors regarding the RFP;
requiring each of the contacted vendors to accept the CDA before granting said vendor access to the RFP;
providing each interested vendor with an electronic proposal form containing pre-defined questions and/or requests for information related to the RFP to be completed by the vendor;
receiving a completed proposal form from each interested vendor;
generating a proposal comparison page via the user interface through which data contained in each interested vendor's proposal form is displayed in a side-by-side comparison format, thereby assisting the sponsor in determining which matched vendor will be best suited for the associated project; and
allowing the sponsor to select one of the matched vendors to provide the requested services.

2. The method of claim 1, wherein the step of obtaining sponsor data further comprises the step of obtaining at least one of a sponsor name, sponsor address, sponsor phone number, sponsor email address, and sponsor description.

3. The method of claim 2, wherein the step of obtaining sponsor data further comprises the step of obtaining data concerning at least one of clinical study Phases, study designs, therapeutic areas, study types, formulation types and routes of administration, settings supported, regulatory authorities, regulatory services, quality, safety, data, information technology, statistics, patient recruitment, sites, studies, investigators, routine safety labs, and central imaging services.

4. The method of claim 1, wherein the step of obtaining vendor data further comprises the step of obtaining at least one of a vendor name, vendor address, vendor phone number, vendor email address, vendor description, vendor ratings, average vendor bid size, and average vendor response time for each one of the at least one vendor.

5. The method of claim 4, wherein the step of obtaining vendor data further comprises the step of obtaining data concerning at least one of vendor size, types of services the vendor is capable of rendering, types of services the vendor has actually rendered to other sponsors, and the names of such sponsors with which the vendor has worked.

6. The method of claim 1, wherein the step of obtaining RFP data further comprises the step of obtaining at least one of a project summary, a list of project services that are needed by the sponsor, a list of deliverables that the at least one vendor would be expected to provide, a project timeline having key milestone dates related to the RFP, and vendor criteria setting forth the particular qualities that the sponsor would like the at least one vendor to embody.

7. The method of claim 6, wherein the step of obtaining RFP data further comprises the step of obtaining data concerning at least one of clinical study Phases, study designs, study objectives, clinical services provided, therapeutic areas, indications, study types, formulation types and routes of administration, settings, regulatory institutions, regulatory services, and subject-related information such as age range, number and gender.

8. The method of claim 1, wherein the step of obtaining RFP data further comprises the step of obtaining a black list comprising a list of vendors with which the sponsor refuses to work.

9. The method of claim 8, further comprising the step of excluding any vendors present on the black list from being on the matched vendor list.

10. The method of claim 1, wherein the step of obtaining RFP data further comprises the step of obtaining a white list comprising a list of vendors with which the sponsor will only work.

11. The method of claim 10, further comprising the step of excluding any vendors not present on the white list from being on the matched vendor list.

12. The method of claim 1, further comprising the step of dynamically updating the vendor data related to the at least one vendor upon the occurrence of any new vendor-related activity within the computing system.

13. The method of claim 1, further comprising the step of allowing each of the contacted vendors to selectively negotiate the terms of the CDA with the sponsor prior to accepting the CDA.

14. The method of claim 1, wherein the step of searching the database server for vendors that the sponsor would potentially find suitable further comprises the steps of:
for each vendor in the database server, comparing at least one of the sponsor data and RFP data against the associated vendor data; and
for vendors that are determined by the computing system to possess a minimum acceptable number of matched data points, adding said vendors to the matched vendor list.

15. The method of claim 14, wherein the step of searching the database server for vendors that the sponsor would potentially find suitable further comprises the step of utilizing a dynamic multi-factor matching algorithm, said matching algorithm comprising the steps of:
continuously and actively evaluating and re-evaluating the vendor data associated with the at least one vendor as the RFP data and/or vendor data might change; and
adjusting the matched vendor list accordingly.

16. The method of claim 14, wherein the step of searching the database server for vendors that the sponsor would potentially find suitable further comprises the step of utilizing an adaptive multi-factor matching algorithm, said matching algorithm comprising the steps of:
upon the computing system determining that the matched vendor list contains too many matched vendors, based on a pre-defined ceiling value, dynamically raising the minimum acceptable number of matched data points, thereby reducing the number of matched vendors contained in the matched vendor list;
upon the computing system determining that the matched vendor list contains too few matched vendors, based on a pre-defined floor value, dynamically lowering the minimum acceptable number of matched data points, thereby increasing the number of matched vendors contained in the matched vendor list; and
repeating these steps until the computing system determines that the matched vendor list contains an acceptable number of matched vendors.

17. The method of claim 1, further comprising the step of ordering the matched vendor list based on the strength of the match between the sponsor and each matched vendor.

18. The method of claim 1, further comprising the step of allowing each of the contacted vendors the ability to submit questions to and receive answers from the sponsor through the computing system.

19. The method of claim 1, further comprising the step of providing, via the user interface, a project dashboard through which the sponsor may view at least one of the status of each contacted vendor and key milestones dates related to the RFP.

20. A method for dynamically matching a sponsor with an at least one vendor in connection with a request for proposal (“RFP”), the method comprising the steps of:
implementing a central computing system configured for receiving, processing and transmitting sponsor data related to the sponsor, vendor data related to the at least one vendor, and RFP data related to the RFP;
providing a database server in communication with the computing system and configured for selectively storing said sponsor data, vendor data and RFP data;
allowing the sponsor to create the RFP using an at least one computing device in communication with the computing system;
obtaining a confidential disclosure agreement (“CDA”) corresponding to the RFP;
automatically searching the database server for vendors that the sponsor would potentially find suitable for the project associated with the RFP by performing the steps of:
for each vendor in the database server, comparing at least one of the sponsor data and RFP data against the associated vendor data;
for vendors that are determined by the computing system to possess a minimum acceptable number of matched data points, adding said vendors to a matched vendor list;
upon the computing system determining that the matched vendor list contains too many matched vendors, based on a pre-defined ceiling value, dynamically raising the minimum acceptable number of matched data points, thereby reducing the number of matched vendors contained in the matched vendor list;
upon the computing system determining that the matched vendor list contains too few matched vendors, based on a pre-defined floor value, dynamically lowering the minimum acceptable number of matched data points, thereby increasing the number of matched vendors contained in the matched vendor list; and
repeating these steps until the computing system determines that the matched vendor list contains an acceptable number of matched vendors;
presenting the sponsor with the matched vendors list;
allowing the sponsor to direct the computing system to send an appropriate notification to at least one of the matched vendors regarding the RFP;
requiring each of the contacted vendors to accept the CDA before granting said vendor access to the RFP;
providing each interested vendor with an electronic proposal form containing pre-defined questions and/or requests for information related to the RFP to be completed by the vendor;
receiving a completed proposal form from each interested vendor; and
allowing the sponsor to review the completed proposal forms and select one of the matched vendors to provide the requested services.

21. A method for dynamically matching a sponsor with an at least one vendor in connection with a request for proposal (“RFP”), the method comprising the steps of:
implementing a central computing system configured for receiving, processing and transmitting sponsor data related to the sponsor, vendor data related to the at least one vendor, and RFP data related to the RFP;
providing a database server in communication with the computing system and configured for selectively storing said sponsor data, vendor data and RFP data;
allowing the sponsor to create the RFP using an at least one computing device in communication with the computing system;
obtaining a confidential disclosure agreement (“CDA”) corresponding to the RFP;
searching the database server for vendors that the sponsor would potentially find suitable for the project associated with the RFP;
compiling said potentially suitable vendors in a matched vendors list ordered based on the strength of the match between the sponsor and each matched vendor;
presenting the sponsor with the matched vendors list;
allowing the sponsor to direct the computing system to send an appropriate notification to at least one of the matched vendors regarding the RFP;
requiring each of the contacted vendors to accept the CDA before granting said vendor access to the RFP;
allowing each of the contacted vendors the ability to submit questions to and receive answers from the sponsor through the computing system;
providing each interested vendor with an electronic proposal form containing pre-defined questions and/or requests for information related to the RFP to be completed by the vendor;
receiving a completed proposal form from each interested vendor; and
allowing the sponsor to review the completed proposal forms and select one of the matched vendors to provide the requested services.
